(19) United States
(12) Patent Application Publication
(10) Pub. No.: US 2025/0223707 A1
(43) Pub. Date: Jul. 10, 2025

(54) HYDROGEN GENERATION SYSTEM AND HYDROGEN GENERATION METHOD

(71) Applicant: MITSUBISHI HEAVY INDUSTRIES, LTD., Tokyo (JP)

(72) Inventors: Naohiko Matsuda, Tokyo (JP); Ryutaro Mori, Tokyo (JP); Yasushi Iwai, Tokyo (JP); Kentaro Shikata, Tokyo (JP)

(73) Assignee: MITSUBISHI HEAVY INDUSTRIES, LTD., Tokyo (JP)

(21) Appl. No.: 18/850,812

(22) PCT Filed: Jan. 18, 2023
(86) PCT No.: PCT/JP2023/001257

§ 371 Date: Sep. 25, 2024

(30) Foreign Application Priority Data
Mar. 31, 2022 (JP) 2022-059695

(51) Int. Cl. C25B 1/042; C25B 9/17; C25B 9/65; C25B 15/02; C25B 15/08; F01K 7/16; F01K 15/00; F02C 3/04; F02C 6/00; H02K 7/18

(52) U.S. Cl. CPC C25B 1/042; C25B 9/17; C25B 9/65; C25B 15/02; C25B 15/08; F01K 7/16; F01K 15/00; F02C 3/04; F02C 6/00; H02K 7/1823; F05D 2220/64; F05D 2220/76

(57) ABSTRACT

Provided is a power generation system (100) comprising: a gas turbine (10) for combusting air compressed by a compressor (11) and a fuel gas using a combustor (12) to generate combustion gas and drive a turbine (13) and a compressor connected to the turbine using the combustion gas; a heat storage structure (30) heated by the combustion gas with which the turbine is driven; a boiler (40) for generating steam using heat stored in the heat storage structure (30); and a solid oxide electrolytic cell (50) having a hydrogen electrode (51), an oxygen electrode (52), and an electrolyte layer (53) positioned between the hydrogen electrode and the oxygen electrode, the solid oxide electrolytic cell (50) supplying steam generated by the boiler (40) to the hydrogen electrode (51) to generate hydrogen through steam electrolysis.

### TECHNICAL FIELD

The present disclosure relates to a hydrogen generation system and a hydrogen generation method.

### BACKGROUND ART

In the related art, a device for generating hydrogen by using surplus power or the like generated in renewable energy power generation equipment such as a solar power generation facility is known (refer to, for example, PTLs 1 and 2). PTL 1 relates to a device including a solid oxide electrolysis cell (SOEC), and discloses a technique in which reaction heat of a fuel cell that generates electricity by using hydrogen generated in the SOEC is recovered to a heat storage device to heat steam that is supplied to the SOEC. In addition, PTL 2 discloses a technique in which steam generated by heat recovered from an exhaust output of a gas turbine system is supplied to an electrolysis unit to generate a hydrogen gas from the steam.

### CITATION LIST

### Patent Literature

[PTL 1] Japanese Unexamined Patent Application Publication No. 2019-173082
[PTL 2] Japanese Unexamined Patent Application Publication No. 2014-141965

### SUMMARY OF INVENTION

### Technical Problem

However, in PTL 1, the reaction heat of the fuel cell that operates at the same time as the SOEC is used. Therefore, the heat generated in another device that may be stopped when the SOEC is operated cannot be effectively utilized.

In addition, in PTL 2, the hydrogen gas is generated using the heat recovered from the exhaust output of the gas turbine system, and the generated hydrogen gas is used as fuel of the gas turbine system. Therefore, the heat generated in another device that may be stopped when the gas turbine system is operated cannot be effectively utilized.

As described above, in both of PTL 1 and PTL 2, the heat generated in another device that may be stopped when hydrogen is generated cannot be effectively utilized. For example, in a case where hydrogen is generated using surplus power that is supplied from the renewable energy power generation equipment, heat generated in another power generation device that operates only in a time zone where the amount of power that is supplied from the renewable energy power generation equipment is reduced (nighttime in the case of solar power generation) cannot be effectively utilized.

The present disclosure has been made in view of such circumstances, and an object thereof is to provide a hydrogen generation system and a hydrogen generation method, in which it is possible to generate hydrogen by effectively utilizing heat generated in a gas turbine that may be stopped when hydrogen is generated.

### Solution to Problem

In order to solve the above problems, the present disclosure adopts the following means.

A hydrogen generation system according to the present disclosure includes: a gas turbine that generates a combustion gas by combusting air compressed by a compressor and a fuel gas in a combustor, and that drives a turbine and the compressor connected to the turbine with the combustion gas; a heat storage structure that is heated with the combustion gas that has driven the turbine; a steam generation unit that generates steam by using heat stored in the heat storage structure; and an electrolysis cell that includes a cathode, an anode, and an electrolyte layer disposed between the cathode and the anode, and that generates hydrogen with steam electrolysis by supplying the steam generated in the steam generation unit to the cathode.

A hydrogen generation method according to the present disclosure is a hydrogen generation method for generating hydrogen by using a hydrogen generation system, in which the hydrogen generation system includes a gas turbine that generates a combustion gas by combusting air compressed by a compressor and a fuel gas in a combustor, and that drives a turbine and the compressor connected to the turbine with the combustion gas, and an electrolysis cell that includes a cathode, an anode, and an electrolyte layer disposed between the cathode and the anode, the hydrogen generation method including: a heating step of heating a heat storage structure with the combustion gas that has driven the turbine; a steam generation step of generating steam by using heat stored in the heat storage structure; and an operation step of operating the electrolysis cell to generate hydrogen with steam electrolysis by supplying the steam generated in the steam generation step to the cathode.

### Advantageous Effects of Invention

According to the present disclosure, it is possible to provide a hydrogen generation system and a hydrogen generation method, in which it is possible to generate hydrogen by effectively utilizing heat generated in a gas turbine that may be stopped when the hydrogen is generated.

### BRIEF DESCRIPTION OF DRAWINGS

FIG. 1 is a diagram showing a schematic configuration of a power generation system according to an embodiment of the present disclosure.

FIG. 2 is a graph showing a relationship between a distance in a first direction from a first surface of a heat storage structure and a temperature.

FIG. 3 is a flowchart showing an operation that is performed by the power generation system.

FIG. 4 is a graph showing an example of a relationship between an elapsed time from a predetermined time, and an amount of supply power and an amount of demand power.

### DESCRIPTION OF EMBODIMENTS

### First Embodiment

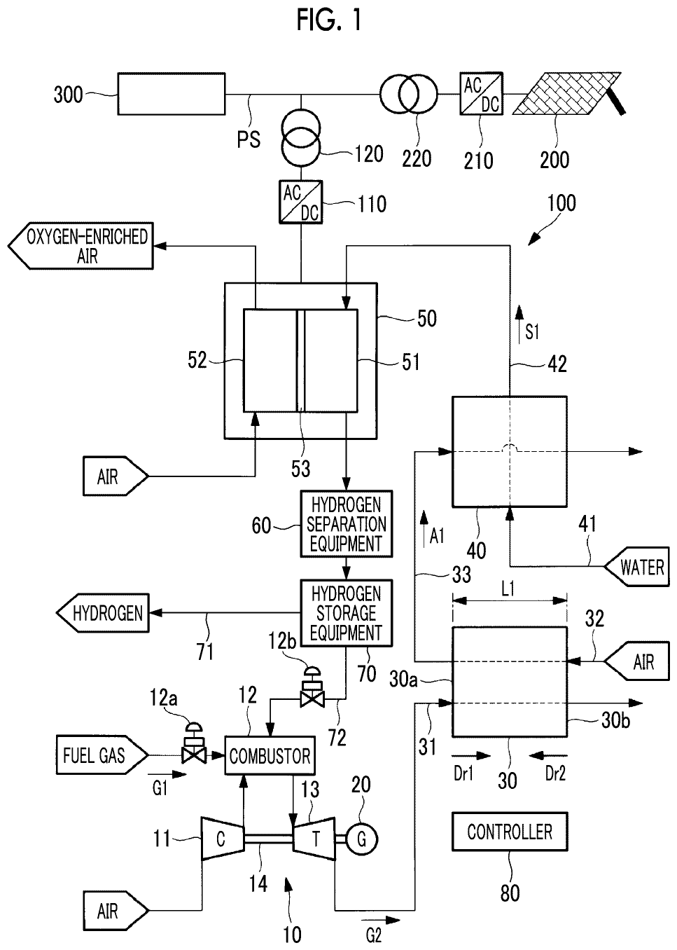

Hereinafter, a power generation system (a hydrogen generation system) 100 according to an embodiment of the present disclosure will be described with reference to FIG. 1. The power generation system 100 of the present embodiment includes a gas turbine 10, an electric generator 20, a heat storage structure 30, a boiler (a steam generation unit) 40, a solid oxide electrolysis cell 50, hydrogen separation equipment 60, hydrogen storage equipment (a storage unit) 70, and a controller (a control unit) 80.

The power generation system 100 supplies electric power generated by the electric generator 20 to a power system PS, and operates the solid oxide electrolysis cell 50 with the electric power that is supplied from the power system PS. The power system PS is supplied with electric power from renewable energy power generation equipment 200 such as a solar power generation facility via an output converter 210 and a transformer 220.

The electric power output to the power system PS is supplied to load equipment 300. In addition, the electric power that is supplied to the power system PS is supplied to the solid oxide electrolysis cell 50 of the power generation system 100 via a transformer 120 and an output converter 110. For example, in a case where the electric power that is supplied from the renewable energy power generation equipment 200 is larger than the electric power that is required by the load equipment 300 and surplus power is generated, the power system PS supplies the surplus power to the solid oxide electrolysis cell 50 of the power generation system 100.

The gas turbine 10 includes a compressor 11, a combustor 12, a turbine 13, and a rotary shaft 14. The compressor 11 takes in air, compresses the air, and supplies the compressed air to the combustor 12 as combustion air. The combustor 12 generates a combustion gas G2 by mixing the air supplied from the compressor 11 and a fuel gas G1 and combusting the mixture, and supplies the combustion gas G2 to the turbine 13. The turbine 13 is rotated by the combustion gas G2 to drive the compressor 11 and the electric generator 20 connected via the rotary shaft 14.

In a case where the controller 80 controls a control valve 12a to be in an open state, the fuel gas G1 is supplied to the combustor 12. In addition, in a case where the controller 80 controls a control valve 12b to be in an open state, hydrogen is supplied to the combustor 12 from the hydrogen storage equipment 70. The fuel gas G1 is, for example, a gas obtained by vaporizing a liquefied natural gas (LNG), a natural gas, a city gas, hydrogen (H₂), carbon monoxide (CO), a hydrocarbon gas such as methane (CH₄), a gas obtained by a gasification facility of a carbonaceous raw material (petroleum, coal, or the like), or the like.

The electric generator 20 is a device that is connected to the turbine 13 via the rotary shaft 14 and that generates electricity in accordance with the rotation of the turbine 13. The electric power generated by the electric generator 20 is supplied to the power system PS. The electric power generated by the electric generator 20 may be supplied to another power system different from the power system PS or to other load equipment.

The heat storage structure 30 is a structure that is heated by the combustion gas G2 that has driven the turbine 13. The heat storage structure 30 is formed of, for example, a ceramic material such as brick, and a flow path through which the combustion gas G2 can pass is provided inside the heat storage structure 30. The heat storage structure 30 may have a heat storage material that is sealed in a capsule and that is heated by the combustion gas G2 to be melted into a molten salt or a molten metal. As shown in FIG. 1, the heat storage structure 30 has a length L1 along a first direction Dr1 which is a circulation direction of the combustion gas G2.

As the heat storage material, for example, a molten salt obtained by mixing sodium nitrate (NaNO₃) and potassium nitrate (KNO₃) can be used. In addition, as the heat storage material, for example, a molten metal containing an aluminum alloy can be used.

The power generation system 100 of the present embodiment includes a combustion gas inflow pipe (a first pipe) 31 that allows the combustion gas G2 to flow into the heat storage structure 30. The combustion gas inflow pipe 31 causes the combustion gas G2 discharged from the gas turbine 10 to flow into the heat storage structure 30 from a first surface 30a along the first direction Dr1. The combustion gas G2 that has flowed into the heat storage structure 30 from the first surface 30a heats each part of the heat storage structure 30 along the first direction Dr1, and is discharged to the outside from a second surface 30b.

The power generation system 100 of the present embodiment includes an air inflow pipe (a second pipe) 32 that allows air (a heat medium) A1 to flow into the heat storage structure 30. The air inflow pipe 32 causes the air A1 to flow into the heat storage structure 30 from the second surface 30b along a second direction Dr2 (being a reverse direction) facing the first direction Dr1. The air A1 that has flowed into the heat storage structure 30 from the second surface 30b is heated from each part of the heat storage structure 30 along the second direction Dr2, and is discharged from the first surface 30a to an air supply pipe 33. The air A1 discharged to the air supply pipe 33 is led to the boiler 40.

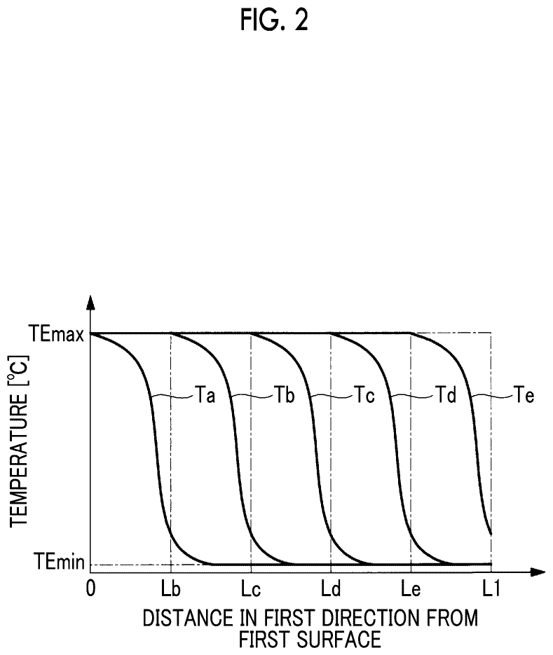

The reason why the air A1 that is supplied to the boiler 40 flows into the heat storage structure 30 along the second direction Dr2 is for allowing the air A1 to flow out from an upstream side (downstream side in the second direction Dr2) in the first direction Dr1 in which heat is most likely to be stored, and for stably maintaining the temperature of the air A1 at a high temperature. FIG. 2 is a graph showing a relationship between a distance in the first direction from the first surface of the heat storage structure and a temperature. In FIG. 2, Ta, Tb, Tc, Td, and Te indicate elapsed times for the combustion gas G2 to pass through the heat storage structure 30, and have a relationship of Ta<Tb<Tc<Td<Te.

In FIG. 2, a temperature TEmax is the temperature of the combustion gas G2 flowing into the heat storage structure 30 from the combustion gas inflow pipe 31, and is, for example, a temperature of 500° C. or higher and 750° C. or lower. A temperature TEmin is an environmental temperature before the combustion gas G2 flows into the heat storage structure 30, and is, for example, a temperature of 10° C. or higher and 30° C. or lower.

As shown in FIG. 2, at the time Ta, the temperature of a portion of the heat storage structure 30 at a distance of 0 from the first surface 30a in the first direction Dr1 (that is, the first surface 30a itself) is TEmax. The temperature decreases as the distance in the first direction Dr1 from the first surface 30a increases. At the time Tb, the temperature of a region of the heat storage structure 30 in which the distance in the first direction Dr1 from the first surface 30a is in a range of 0 to Lb is TEmax, and the region in which the temperature is TEmax increases compared to that at the time Ta.

The region where the temperature TEmax of the heat storage structure 30 is reached gradually increases as the elapsed time for the combustion gas G2 to pass through the heat storage structure 30 becomes longer such as the time Ta, the time Tb, the time Tc, the time Td, and the time Te. In this manner, the heat is more likely to be stored in the heat storage structure 30 as the distance in the first direction Dr1 from the first surface 30a becomes shorter.

The air A1 flows into the second surface 30b of the heat storage structure 30 from the air inflow pipe 32. However, the downstream side in the second direction Dr2 where the air A1 flows out from the heat storage structure 30 is the upstream side in the first direction Dr1. In FIG. 2, which is a graph showing the relationship between the distance in the first direction Dr1 from the first surface 30a of the heat storage structure 30 and a temperature, Ta, Tb, Tc, Td, and Te indicate the elapsed times for the air A1 to pass through the heat storage structure 30, and have a relationship of Te<Td<Tc<Tb<Ta. Since the air A1 flows out to the air supply pipe 33 from the first surface 30a on the upstream side in the first direction Dr1 where the air A1 is most easily heated, the air A1 can flow out while stably maintaining a high temperature. The temperature of the air A1 flowing out to the air supply pipe 33 is, for example, 500° C. or higher and 750° C. or lower.

The boiler 40 is a device that generates steam by using the heat stored in the heat storage structure 30 and that supplies the steam to the solid oxide electrolysis cell 50. The heat stored in the heat storage structure 30 is supplied to the boiler 40 as the air A1 heated by the heat storage structure 30. The boiler 40 generates steam S1 by heating water that is supplied from a water supply pipe 41 with the air A1 that is supplied from the air supply pipe 33. The steam S1 is supplied to a cathode 51 of the solid oxide electrolysis cell 50 through a steam supply pipe 42. The temperature of the steam S1 that is supplied to the cathode 51 is, for example, 400° C. or higher.

The solid oxide electrolysis cell 50 is a device that generates hydrogen and oxygen with steam electrolysis by supplying the steam S1 generated by the boiler 40 to the cathode 51. The solid oxide electrolysis cell 50 includes the cathode 51, an anode 52, and an electrolyte layer 53 disposed between the cathode 51 and the anode 52.

The cathode 51 is made of an oxide of a composite material of Ni and zirconia-based electrolyte material, and, for example, Ni/YSZ is used. The anode 52 is made of, for example, a LaSrMnO₃-based oxide or a LaCoO₃-based oxide. As the electrolyte layer 53, for example, YSZ having airtightness through which a gas hardly passes and high oxygen ion conductivity at a high temperature is mainly used.

The solid oxide electrolysis cell 50 shown in FIG. 1 schematically shows the relationship between the cathode 51, the anode 52, and the electrolyte layer 53. As the solid oxide electrolysis cell 50, for example, a cylindrical cell stack in which the cathode 51 is disposed in a tubular body made in a cylindrical shape by using a porous material, the electrolyte layer 53 is disposed on the cathode 51, and the anode 52 is disposed on the electrolyte layer 53 can be used.

When the electric power that is supplied from the power system PS is supplied between the cathode 51 and the anode 52, a part of the high-temperature steam S1 supplied to the cathode 51 receives electrons to be separated into hydrogen and oxygen ions, and generates hydrogen. The separated oxygen ions move to the anode 52 inside the electrolyte layer 53, and release electrons to generate oxygen.

The hydrogen separation equipment 60 is equipment that separates hydrogen by removing steam from a mixed gas of hydrogen generated in the cathode 51 of the solid oxide electrolysis cell 50 and steam. The hydrogen separation equipment 60 supplies the hydrogen separated from the mixed gas to the hydrogen storage equipment.

The hydrogen storage equipment 70 is equipment that stores the hydrogen that is supplied from the hydrogen separation equipment 60, and supplies the hydrogen to a hydrogen supply destination via a hydrogen supply pipe 71. In addition, the hydrogen storage equipment 70 can supply the hydrogen to the combustor 12 of the gas turbine 10 via a hydrogen supply pipe 72. The hydrogen storage equipment 70 supplies the hydrogen as fuel of the combustor 12 in a case where the controller 80 controls the control valve 12b to be in an open state.

The controller 80 is a device that controls the power generation system 100. The controller 80 includes a storage unit (not shown) that stores a control program and a calculation unit (not shown) that executes the program, and executes various operations of controlling the power generation system 100 by executing the program read from the storage unit in the calculation unit.

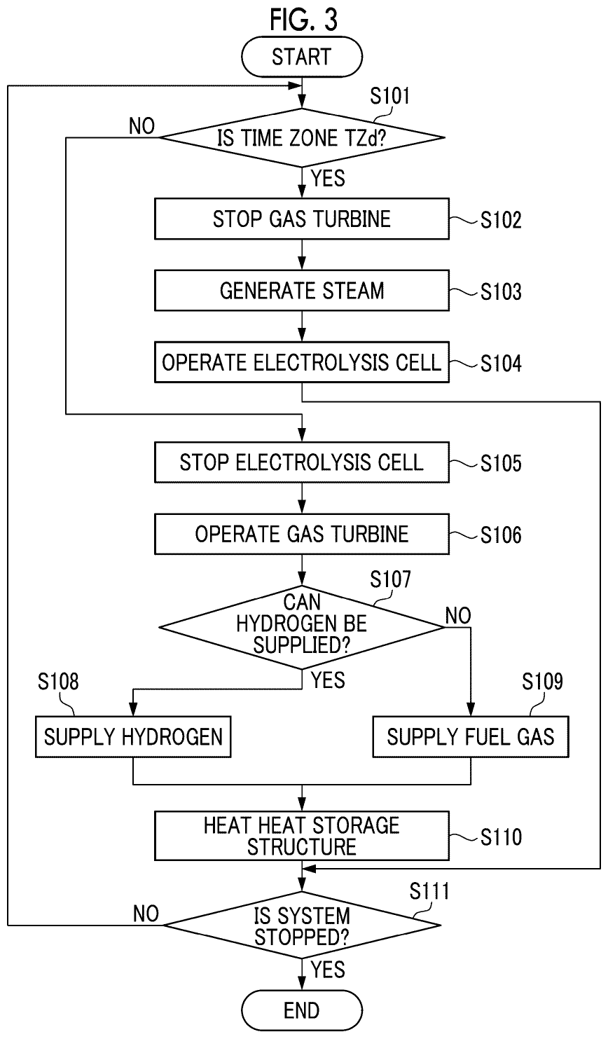

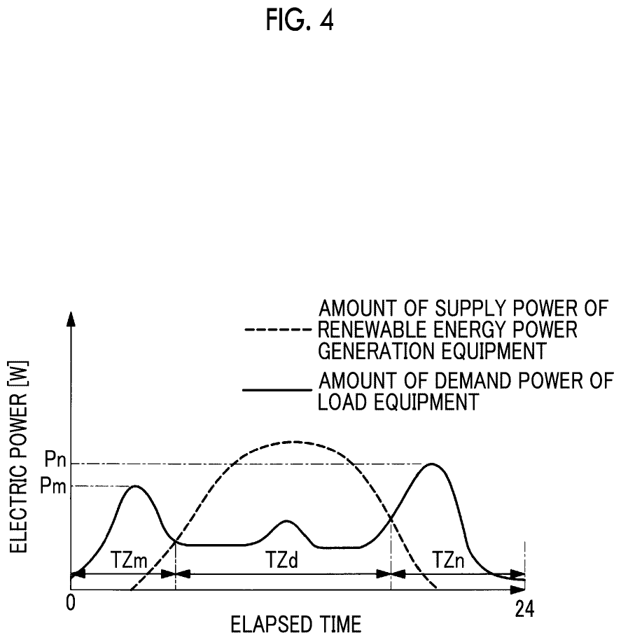

Next, an operation that is performed by the power generation system 100 of the present embodiment will be described with reference to the drawings. FIG. 3 is a flowchart showing an operation that is performed by the power generation system 100 of the present embodiment. FIG. 4 is a graph showing an example of a relationship between an elapsed time from a predetermined time, and an amount of supply power and an amount of demand power.

In FIG. 4, the predetermined time is, for example, 3:00 a.m., and the elapsed time indicates a time until 24 hours elapse from the predetermined time. A solid line shown in FIG. 4 shows an example of the amount of demand power of the load equipment 300. The amount of demand power of the load equipment 300 is particularly large in a part of a time zone TZm from midnight to morning and a part of a time zone TZn from evening to midnight. In a time zone TZd of the daytime, the amount of demand power of the load equipment 300 is smaller than a peak power amount Pm in the time zone TZm and a peak power amount Pn in the time zone TZn at any time.

A dotted line shown in FIG. 4 indicates the amount of supply power that is supplied from the renewable energy power generation equipment 200. The amount of supply power of the renewable energy power generation equipment 200 is large in the time zone TZd, and is small or zero in the time zone TZm and the time zone TZn. The amount of supply power of the renewable energy power generation equipment 200 exceeds the amount of demand power of the load equipment 300 in the time zone TZd. In the example shown in FIG. 4, in the time zone TZd, the surplus power amount obtained by subtracting the amount of demand power of the load equipment 300 from the amount of supply power of the renewable energy power generation equipment 200 is generated.

In step S101 in FIG. 3, the controller 80 determines whether or not the current time zone is TZd, and in the case of YES, the processing proceeds to step S102, and in the case of NO, the processing proceeds to step S105.

In step S102, the controller 80 performs control to stop the gas turbine 10, because the surplus power of the renewable energy power generation equipment 200 is generated in the time zone TZd.

In step S103, the air A1 is supplied from the air inflow pipe 32 to the heat storage structure 30 heated by the combustion gas G2 in step S107 to be described later, and the heated air A1 is supplied to the boiler 40. The boiler 40 generates the steam S1 by heating the water supplied from the water supply pipe 41 with the air A1, and leads the steam S1 to the cathode 51.

In step S104, the controller 80 supplies the surplus power that is output from the renewable energy power generation equipment 200 to the power system PS to the solid oxide electrolysis cell 50 and causes the solid oxide electrolysis cell 50 to be in an operating state. The solid oxide electrolysis cell 50 generates hydrogen and stores the hydrogen in the hydrogen storage equipment 70.

When the solid oxide electrolysis cell 50 is operated in step S104, the heat of the heat storage structure 30 heated by the combustion gas G2 that is supplied from the gas turbine 10 is used as the heat source of the steam S1 that is supplied to the cathode 51. When the solid oxide electrolysis cell 50 is operated, although the gas turbine 10 is stopped, the heat stored in the heat storage structure 30 can be used as a heat source for generating the steam S1.

In step S105, the controller 80 stops the solid oxide electrolysis cell 50, because the time zone is TZm or TZn, and the surplus power of the renewable energy power generation equipment 200 is not generated.

In step S106, the controller 80 performs control to operate the gas turbine 10 to satisfy the amount of demand power, because the time zone is TZm or TZn and the amount of demand power of the load equipment 300 is larger than the amount of supply power of the renewable energy power generation equipment 200. The gas turbine 10 is operated, so that the electric generator 20 is driven to generate electric power, and the electric power is supplied to the load equipment 300 via the power system PS.

In step S107, the controller 80 determines whether or not the hydrogen can be supplied from the hydrogen storage equipment 70 to the combustor 12 via the hydrogen supply pipe 72, and in the case of YES, the processing proceeds to step S108, and in the case of NO, the processing proceeds to step S109. The controller 80 determines that the hydrogen can be supplied to the combustor 12, for example, in a case where the hydrogen storage equipment 70 stores more hydrogen than a predetermined threshold value.

In step S108, the controller 80 brings the control valve 12b into an open state to supply the hydrogen from the hydrogen storage equipment 70 to the combustor 12 via the hydrogen supply pipe 72. The combustor 12 mixes the hydrogen supplied from the hydrogen storage equipment 70 with the air supplied from the compressor 11 and combusts the mixture.

In step S109, the controller 80 brings the control valve 12a into an open state to supply the fuel gas to the combustor 12. The combustor 12 mixes the hydrogen supplied from the hydrogen storage equipment 70 with the air supplied from the compressor 11 and combusts the mixture.

In step S110, the combustion gas G2 generated by the gas turbine 10 during operation is supplied to the heat storage structure 30 to heat the heat storage structure 30. The heat storage structure 30 is heated in accordance with the amount of heat and the supply time of the combustion gas G2 that is supplied from the gas turbine 10, and stores the heat of the combustion gas G2.

The combustion gas G2 generated in the combustor 12 in steps S108 and S109 is supplied to the heat storage structure 30 in step S110 and is stored in the heat storage structure 30. Since the solid oxide electrolysis cell 50 is stopped during the operation of the gas turbine 10, the combustion gas G2 cannot be directly used as the heat source of the steam S1 that is used during the operation of the solid oxide electrolysis cell 50. Therefore, in step S110, the heat of the combustion gas G2 is stored in the heat storage structure 30, so that the combustion gas G2 can be indirectly used as the heat source of the steam S1 that is used during the operation of the solid oxide electrolysis cell 50.

In step S111, the controller 80 determines whether or not a stop condition for stopping the power generation system 100 is satisfied, and in the case of YES, the controller 80 stops the power generation system 100 and ends the processing of the flowchart. When the determination in step S111 is NO, the controller 80 repeatedly executes the processing from step S101.

The operation and effect of the power generation system 100 of the present embodiment described above will be described.

According to the power generation system 100 of the present embodiment, the heat storage structure 30 is heated by the combustion gas G2 generated by combusting the fuel gas G1 in the gas turbine 10, so that the heat of the combustion gas G2 is retained. The boiler 40 generates the steam S1 with the heat stored in the heat storage structure 30 and supplies the steam S1 to the cathode 51 of the solid oxide electrolysis cell 50. The solid oxide electrolysis cell 50 generates hydrogen by steam-electrolyzing the steam S1 supplied to the cathode 51.

As the electric power required when the solid oxide electrolysis cell 50 performs the steam electrolysis, for example, the surplus power that is supplied from the renewable energy power generation equipment 200 is used. In a case where the solid oxide electrolysis cell 50 is operated in the time zone TZd in which the surplus power can be used, although the gas turbine 10 is stopped, the heat of the combustion gas G2 generated during the operation of the gas turbine 10 is stored in the heat storage structure 30. Therefore, the boiler 40 can generate the steam S1 by using the heat stored in the heat storage structure 30 and supply the steam S1 to the solid oxide electrolysis cell 50. In this manner, according to the power generation system 100 of the present embodiment, the heat of the combustion gas G2 generated in the gas turbine 10, which is another device that may be stopped when hydrogen is generated, can be effectively utilized.

In addition, according to the power generation system 100 of the present embodiment, since the combustion gas G2 that is discharged from the gas turbine 10 flows into the heat storage structure 30 along the first direction Dr1, the upstream side in the first direction Dr1 is most likely to store heat and the heat of the combustion gas G2 propagates from the upstream side toward the downstream side. Meanwhile, since the air A1 flows into the heat storage structure 30 along the second direction Dr2 facing the first direction Dr1, the downstream side in the second direction Dr2, from which the air A1 flows out from the heat storage structure 30, becomes the upstream side in the first direction Dr1. Since the air A1 flows out from the upstream side in the first direction Dr1 where the air A1 is most likely to store heat, the air A1 can flow out while stably maintaining a high temperature.

In addition, according to the power generation system 100 of the present embodiment, since the heat storage structure 30 is formed of a relatively inexpensive ceramic material such as brick, the manufacturing cost of the heat storage structure 30 can be reduced.

In addition, according to the power generation system 100 of the present embodiment, since the heat storage structure 30 has the heat storage material that is heated by the combustion gas G2 to be melted into a molten salt or a molten metal, an installation area of the heat storage structure 30 can be reduced as compared with a case where the heat storage structure 30 is formed of a ceramic material.

In addition, according to the power generation system 100 of the present embodiment, the hydrogen generated by the solid oxide electrolysis cell 50 can be stored in the hydrogen storage equipment 70, and the hydrogen can be supplied from the hydrogen supply pipe 72 to the combustor 12 at a timing when the gas turbine 10 is operated. Therefore, the hydrogen generated by using the heat of the combustion gas G2 generated in the gas turbine 10 can be utilized as the fuel of the combustor 12 of the gas turbine 10, and the fuel consumption of the power generation system 100 can be reduced.

The power generation system described in each of the embodiments described above is understood as follows, for example.

A hydrogen generation system (100) according to the present disclosure includes: a gas turbine (10) that generates a combustion gas by combusting air compressed by a compressor (11) and a fuel gas in a combustor (12), and that drives a turbine (13) and the compressor connected to the turbine with the combustion gas; a heat storage structure (30) that is heated with the combustion gas that has driven the turbine; a steam generation unit (40) that generates steam by using heat stored in the heat storage structure; and an electrolysis cell (50) that includes a cathode (51), an anode (52), and an electrolyte layer (53) disposed between the cathode and the anode, and that generates hydrogen with steam electrolysis by supplying the steam generated in the steam generation unit to the cathode.

According to the hydrogen generation system according to the present disclosure, the heat storage structure is heated by the combustion gas generated by combusting the fuel gas in the gas turbine, so that the heat of the combustion gas is retained. The steam generation unit generates steam by using heat stored in the heat storage structure, and supplies the steam to the cathode of the electrolysis cell. The electrolysis cell generates hydrogen by steam-electrolyzing the steam supplied to the cathode.

As the electric power required when the electrolysis cell performs the steam electrolysis, for example, the surplus power that is supplied from the renewable energy power generation equipment or the like is used. In a case where the electrolysis cell is operated in the time zone when the surplus power can be used, although the gas turbine may be stopped, the heat of the combustion gas generated during the operation of the gas turbine is stored in the heat storage structure. Therefore, the steam generation unit can generate steam by using the heat stored in the heat storage structure and supply the steam to the electrolysis cell. In this manner, according to the hydrogen generation system according to the present disclosure, hydrogen can be generated by effectively using the heat of the combustion gas generated in the gas turbine that may be stopped when the hydrogen is generated.

The hydrogen generation system according to the present disclosure may be configured to include a first pipe (31) that causes the combustion gas discharged from the gas turbine to flow into the heat storage structure along a first direction, and a second pipe (32) that causes a heat medium for heating the steam to flow into the heat storage structure along a second direction facing the first direction.

According to the hydrogen generation system according to the present configuration, since the combustion gas that is discharged from the gas turbine flows into the heat storage structure along the first direction, the upstream side in the first direction is most likely to store heat, and the heat of the combustion gas propagates from the upstream side toward the downstream side. Meanwhile, since the heat medium (for example, air) flows into the heat storage structure along the second direction facing the first direction, the downstream side in the second direction where the heat medium flows out from the heat storage structure becomes the upstream side in the first direction. Since the heat medium flows out from the upstream side in the first direction where the heat medium is most likely to store heat, the heat medium can flow out while stably maintaining the temperature of the heat medium at a high temperature.

In the hydrogen generation system according to the above configuration, the heat storage structure may be configured to be formed of a ceramic material.

According to the hydrogen generation system of the present configuration, since the heat storage structure is formed of a relatively inexpensive ceramic material such as brick, the manufacturing cost of the heat storage structure can be reduced.

In the hydrogen generation system according to the present disclosure, the heat storage structure may be configured to include a heat storage material that is sealed in a capsule, and that is heated and melted with the combustion gas to become a molten salt or a molten metal.

According to the hydrogen generation system of the present configuration, since the heat storage structure includes the heat storage material that is heated by the combustion gas to be melted into a molten salt or a molten metal, the installation area of the heat storage structure can be reduced as compared with a case where the heat storage structure is formed of a ceramic material.

The hydrogen generation system according to the present disclosure may be configured to include a storage unit (70) that stores the hydrogen generated by the electrolysis cell, and a supply pipe (72) for supplying the hydrogen stored in the storage unit to the combustor.

According to the hydrogen generation system according to the present configuration, the hydrogen generated by the electrolysis cell can be stored in the storage unit, and the hydrogen can be supplied from the supply pipe to the combustor at a timing when the gas turbine is operated. Therefore, the hydrogen generated by using the heat of the combustion gas generated in the gas turbine can be utilized as the fuel of the combustor of the gas turbine, and the fuel consumption of the power generation system can be reduced.

The hydrogen generation system according to the present disclosure may be configured to include an electric generator that is connected to the turbine, and that generates electricity in accordance with rotation of the turbine.

According to the hydrogen generation system of the present configuration, electric power can be generated by the electric generator that generates electricity in accordance with the rotation of the turbine.

A hydrogen generation method according to the present disclosure is a hydrogen generation method for generating hydrogen by using a hydrogen generation system, in which the hydrogen generation system includes a gas turbine that generates a combustion gas by combusting air compressed by a compressor and a fuel gas in a combustor, and that drives a turbine and the compressor connected to the turbine with the combustion gas, and an electrolysis cell that includes a cathode, an anode, and an electrolyte layer disposed between the cathode and the anode, the hydrogen generation method including: a heating step of heating a heat storage structure with the combustion gas that has driven the turbine; a steam generation step of generating steam by using heat stored in the heat storage structure; and an operation step of operating the electrolysis cell to generate hydrogen with steam electrolysis by supplying the steam generated in the steam generation step to the cathode.

According to the hydrogen generation method according to the present disclosure, the heat storage structure is heated by the combustion gas generated by combusting the fuel gas in the gas turbine, so that the heat of the combustion gas is retained. In the steam generation step, steam is generated by heat stored in the heat storage structure, and the steam is supplied to the cathode of the electrolysis cell. The electrolysis cell generates hydrogen by steam-electrolyzing the steam supplied to the cathode.

As the electric power required when the electrolysis cell performs the steam electrolysis, for example, the surplus power that is supplied from the renewable energy power generation equipment or the like is used. In a case where the electrolysis cell is operated in the time zone when the surplus power can be used, although the gas turbine may be stopped, the heat of the combustion gas generated during the operation of the gas turbine is stored in the heat storage structure. Therefore, in the steam generation step, the steam can be generated by the heat stored in the heat storage structure and can be supplied to the electrolysis cell. In this manner, according to the hydrogen generation method according to the present disclosure, hydrogen can be generated by effectively utilizing the heat of the combustion gas generated in the gas turbine that may be stopped when the hydrogen is generated.

### REFERENCE SIGNS LIST

10: gas turbine
11: compressor
12: combustor
12a, 12b: control valve
13: turbine
14: rotary shaft
20: electric generator
30: heat storage structure
30a: first surface
30b: second surface
31: combustion gas inflow pipe (first pipe)
32: air inflow pipe (second pipe)
33: air supply pipe
40: boiler (steam generation unit)
41: water supply pipe
42: steam supply pipe
50: solid oxide electrolysis cell
51: cathode
52: anode
53: electrolyte layer
60: hydrogen separation equipment
70: hydrogen storage equipment (storage unit)
71, 72: hydrogen supply pipe
80: controller
100: power generation system (hydrogen generation system)
200: renewable energy power generation equipment
300: load equipment
A1: air
Dr1: first direction
Dr2: second direction
G1: fuel gas
G2: combustion gas
PS: power system
Pm, Pn: peak power amount
S1: steam
TZd, TZm, TZn: time zone

1. A hydrogen generation system comprising:
a gas turbine that generates a combustion gas by combusting air compressed by a compressor and a fuel gas in a combustor, and that drives a turbine and the compressor connected to the turbine with the combustion gas;
a heat storage structure that is heated with the combustion gas that has driven the turbine;
a steam generation unit that generates steam by using heat stored in the heat storage structure;
an electrolysis cell that includes a cathode, an anode, and an electrolyte layer disposed between the cathode and the anode, and that generates hydrogen with steam electrolysis by supplying the steam generated in the steam generation unit to the cathode, and
a controller that controls the gas turbine and the electrolysis cell, wherein
in a state where the gas turbine is stopped and the electrolytic cell is in an operating state, the heat medium is supplied to the heat storage structure heated by the combustion gas, the heat medium heated by the heat storage structure is supplied to the steam generation unit to generate steam, and the steam generated in the steam generator is supplied to the cathode.

2. The hydrogen generation system according to claim 1, further comprising:
a first pipe that causes the combustion gas discharged from the gas turbine to flow into the heat storage structure along a first direction; and
a second pipe that causes the heat medium for heating the steam to flow into the heat storage structure along a second direction facing the first direction.

3. The hydrogen generation system according to claim 1,
wherein the heat storage structure is formed of a ceramic material.

4. The hydrogen generation system according to claim 1,
wherein the heat storage structure includes a heat storage material that is sealed in a capsule, and that is heated and melted with the combustion gas to become a molten salt or a molten metal.

5. The hydrogen generation system according to claim 1, further comprising:
a storage unit that stores the hydrogen generated by the electrolysis cell; and
a supply pipe for supplying the hydrogen stored in the storage unit to the combustor.

6. The hydrogen generation system according to claim 1, further comprising:
an electric generator that is connected to the turbine, and that generates electricity in accordance with rotation of the turbine.

7. A hydrogen generation method for generating hydrogen by using a hydrogen generation system, in which the hydrogen generation system includes
a gas turbine that generates a combustion gas by combusting air compressed by a compressor and a fuel gas in a combustor, and that drives a turbine and the compressor connected to the turbine with the combustion gas,
a heat storage structure that is heated with the combustion gas that has driven the turbine;
a steam generation unit that generates steam by using heat stored in the heat storage structure; and
an electrolysis cell that includes a cathode, an anode, and an electrolyte layer disposed between the cathode and the anode, and that generates hydrogen with steam electrolysis by supplying the steam generated in the steam generation unit to the cathode,
the hydrogen generation method comprising:
a heating step of heating a heat storage structure with the combustion gas that has driven the turbine;
a steam generation step of generating steam by using heat stored in the heat storage structure; and
an operation step of operating the electrolysis cell to generate hydrogen with steam electrolysis by supplying the steam generated in the steam generation step to the cathode, wherein
in a state where the gas turbine is stopped and the electrolytic cell is in an operating state, the heat medium is supplied to the heat storage structure heated by the combustion gas, the heat medium heated by the heat storage structure is supplied to the steam generation unit to generate steam, and the steam generated in the steam generator is supplied to the cathode.

8. The hydrogen generation system according to claim 1, further comprising:
an output converter that converts power supplied from a power system which supplies power to load equipment and supplies the power to the electrolysis cell, wherein
the controller is configured to control the gas turbine to be stopped and the electrolytic cell to be in the operating state by supplying the steam generated in the steam generator to the cathode when a current time zone is a first time zone and to control the gas turbine to be in an operating state to heat the storage structure with the combustion gas generated in the gas turbine when a current time zone is a second time zone in which amount of demand power of the load equipment is larger than amount of demand power of the load equipment in the first time zone.

9. The hydrogen generation method according to claim 7, wherein the hydrogen generation system further includes an output converter that converts power supplied from a power system which supplies power to load facilities and supplies the power to the electrolysis cell, wherein
in the operation step, the gas turbine is controlled to be stopped and the electrolytic cell is controlled to be in the operating state by supplying the steam generated in the steam generator to the cathode when a current time zone is a first time zone,
in the heating step, the gas turbine is controlled to be in an operating state to heat the storage structure with the combustion gas generated in the gas turbine when a current time zone is a second time zone in which amount of demand power of the load equipment is larger than amount of demand power of the load equipment in the first time zone.
